(19) United States
(12) Patent Application Publication
(10) Pub. No.: US 2012/0027649 A1
(43) Pub. Date: Feb. 2, 2012

(54) MOUNTING MEDIA DEVICE

(76) Inventor: Sam Bhatia, Omaha, NE (US)

(21) Appl. No.: 13/234,920

(22) Filed: Sep. 16, 2011

Related U.S. Application Data
(63) Continuation-in-part of application No. 13/195,995, filed on Aug. 2, 2011.
(60) Provisional application No. 61/369,951, filed on Aug. 2, 2010.

(51) Int. Cl. B01L 3/00; B67D 7/06; B65D 83/00; G01F 11/00

(52) U.S. Cl. 422/521; 222/179; 222/389; 222/394; 422/553; 422/565

(57) ABSTRACT

A mounting media device for application of mounting media to a specimen positioned on a slide before placement of a cover slip. The mounting media device includes a housing, a tray component, a mounting media transfer component, a dispenser component, and a control element. The mounting media transfer component provides mounting media to the dispenser component. In an automatic mode, a sensor may provide a signal to the control element to cause mounting media to be transferred from the mounting media transfer component to the dispenser component automatically. The dispenser component may dispense the mounting media to the tray component and onto a specimen positioned on a slide before placement of a cover slip. In a manual mode, a trigger element may be depressed so that the mounting media device may be manually controlled and release mounting media from the dispenser component.

This Application is a continuation-in-part of co-pending U.S. Non-Provisional patent application Ser. No. 13/195,995 filed Aug. 2, 2011 the disclosure of which is hereby incorporated by reference in its entirety, and which claims the benefit of U.S. Provisional Patent Application Ser. No. 61/369,951 filed Aug. 2, 2010.

### FIELD OF THE INVENTION

The invention relates generally to microscopy and mounting media positioned between a slide and a cover slip used for specimens. The invention relates to a mounting media device having an automatic mode, a manual mode, and a semi-automatic mode thereby combining the techniques of automated and manual application of mounting media to specimens before placement of cover slips.

The present invention is discussed in the following largely with reference to microscopy related to tissue specimens of the medical industry, but the present invention is applicable to a variety of specimens within a variety of microscopy industries, each of which may utilize or benefit from a dual-mode mounting media device, for example, archaeology, biology, geophysics, materials science, life science, and others.

### BACKGROUND OF THE INVENTION

Use of mounting media is a common and effective way for preserving and protecting tissue specimens, as well as viewing the specimens with a microscope. A microscopic slide and a cover slip are used for a tissue specimen, which is positioned between the slide and cover slip. A cover slip is a thin flat piece of transparent material, usually glass or plastic. It is also known that fused quartz cover slips may be used where ultraviolet transparency is required such as for fluorescence microscopy.

The cover slip serves many functions, including keeping the specimen pressed flat and of even thickness on the slide, holding the specimen in place on the slide by its weight or by surface tension, and protecting the specimen from dust. Additionally, the cover slip protects the lens of the microscope from contacting the specimen.

In certain instances, the cover slip is sealed or glued to the slide by mounting media in order to prevent contamination and decay of the specimen. Typically, mounting media is applied to a specimen positioned on a slide before placement of the cover slip. A number of mounting medias are currently in use such as sealants, laboratory preparations, adhesives, clear nail polish, and “varlap”—an equal part mixture of Vaseline®, lanolin, and paraffin.

Applying mounting media to a specimen may be performed manually by hand, or in bulk by an automated machine. Current dispensers of mounting media come in many forms. Many automated dispensers sit on a surface such as a countertop and require the loading of a basket of slides in order for the mounting media to be applied to the specimen and then cover slipped. The bulk of current automated dispensers can handle multiple applications of mounting media at once and include a hydraulic arm along with a needle tip to dispense the mounting media. In addition these devices also place the cover slip on the slide.

There are certain situations when it is preferable to manually apply mounting media to a specimen before manually placing the cover slip. Typically, manually placing a cover is performed with specimens that are time sensitive or high risk, and also occurs with certain frozen or dermatological procedures. In these instances, setting up an automated dispenser for mounting media may be time-consuming and costly. Furthermore, specimens of a small sample size provide limited room for error—a risky situation should the automated dispenser malfunction.

Manually applying mounting media requires very few materials: a squeeze bottle containing mounting media such as sealant or glue, or a flask with a wooden applicator. However, there are disadvantages of manually applying mounting media to a specimen and manually placing a cover slip to a slide which include, for example, clogging of the sealant or glue, accidental spills, bubbles on slides—distorting architecture, and the sealant or glue drying up if not properly stored.

There is currently no dual-mode device available that combines the techniques of automated and manual application of mounting media to specimens. It would be desirable to have a device that includes two modes—automatic and manual, or a semi-automatic mode that includes a combination of these modes. The present invention satisfies this demand.

### SUMMARY OF THE INVENTION

The present invention is a mounting media device for application of mounting media to a specimen positioned on a slide before placement of a cover slip. In one embodiment, the mounting media device includes a housing having a base, a tray component configured to receive one or more slides, and a mounting media transfer component. The tray component may be configured to be moveable on the base. The mounting media device may further include a dispenser component for dispensing mounting media to one or more of the slides and a control element for controlling the dispensing of the mounting media from the dispenser component to the slides. The mounting media transfer component may be controlled by the control element to transfer mounting media in increments to the dispenser component, which causes a deposit of mounting media in increments from the dispenser component to each of the slides. Moreover, the mounting media transfer component may be operated in a manual mode which operates upon a trigger being actuated, or in an automatic mode that operates based on a sensor signal being received by the control element. The control element can process the sensor signal and cause automatic operation of the mounting media transfer component based on the received sensor signal.

In one embodiment the mounting media device includes an enclosure element forming the housing, a foot pedal element included as part of the control element, a finger trigger element included as part of the control element, and an optical sensor included as part of the control element. The mounting media device also includes a container for supplying mounting media to the mounting media transfer component, a movable slide tray component for receiving one or more slides, a fan and filter assembly, a syringe component forming part of the mounting media transfer component, and a dispenser component having a needle tip.

In one embodiment, the syringe component may include a plunger member. The plunger member of the syringe component may reciprocate to create pressure on mounting media within the syringe and received from a container, such as a glass jar container. A first valve element and a second valve element may be positioned within the syringe component. The first valve element and the second valve element may be alternatively opened and closed to facilitate transfer of mounting media from the syringe component to the dispenser component.

In one embodiment of the invention, in a manual mode, the foot pedal element or the finger trigger element activates the syringe component thereby releasing the mounting media from the dispenser component onto a specimen positioned on a slide and aligned with the needle tip. In an automatic mode, one or more sensors such as optical sensors, push-button sensors, or magnetic sensors are activated which provides a signal causing the syringe component to release mounting media from the dispenser component. A trigger element such as a foot pedal or a finger trigger element may also be actuated to provide a signal causing the syringe component to release mounting media from the dispenser component. The mounting media may be any liquid, cream, liniment, oil, lotion, paste, wax, plastic, or gel.

The present invention may be a mounting media device having a switchable automatic mode and manual mode thereby combining the techniques of automated and manual application of mounting media in a semi-automated format. The device may perform each mode exclusively or in combination.

The housing may be formed of various materials including stainless steel, plastic or sheet metal, and may be of any configuration to hold one or more of the various components of the device described more fully below. In one embodiment, the housing is C-shaped. It is contemplated that the housing includes a filter door capable of being opened to receive a filter. The filter may be a High-Efficiency Particulate Air (“HEPA”) air filter, charcoal filter, or any other variety of filters that eliminate fumes from the air.

In another embodiment, the housing may include a fan and filter assembly that includes one or more air vents to ventilate and reduce the temperature of the mounting media device. In another embodiment, an external fan may attach to the housing to dry slides positioned on a tray component.

In yet another embodiment, the housing may further include one or more handle members to facilitate carrying of the mounting media device. In another embodiment, mounting brackets may be secured to the housing to mount the mounting media device to a structure.

In another embodiment, a bracket supporting one or more cups may secure to the housing. The one or more cups may include a first cup having a dye, a second cup having an alcohol, and a third cup having xylene. In other embodiments, the one or more cups may incorporate a stain line such as a hematoxylin and eosin stain line. In another embodiment, the one or more cups may incorporate a cytological stain line. In another embodiment, the one or more cups may incorporate a diff quick stain line. In yet another embodiment, the one or more cups may incorporate fluids for immunohistochemistry staining.

In a further embodiment, the housing may include a liquid crystal display (“LCD”) touch screen and a universal serial bus (“USB”) port element for providing a control element with a manual mode setting and/or an automatic mode setting.

In another embodiment, the housing may include a recessed area for a container. In another embodiment, the device may include a control element positioned on one side of the housing.

In yet another embodiment, the housing may include a base having a motorized track assembly. A track motor may automatically move the tray component based on commands from the control element. The tray component may include one or more slides that have central areas with specimens. The tray component may be positioned automatically in a central area of one of the slides to receive mounting media. After application of the mounting media to the slide, the track motor can automatically move the tray component to new position with a slide under the dispenser component to receive the next incremental amount of mounting media. This process may continue until all slides are automatically provided with mounting media in a central area of each slide.

In one embodiment, the tray component may hold up to 100 slides and have a manual mode for movement. In the manual mode of movement, the tray component can have slots that guide movement of the tray component. Upon an external force being applied to the tray component, the tray component can be repositioned relative to the dispenser component. In this manner, manual application of mounting media can be applied to a slide on the tray component by application of a trigger, such as the foot pedal element.

In another embodiment, the housing may have a syringe component mounted to the housing. In another embodiment, the mounting media device may include an arm member for holding and positioning of the dispenser component. In one embodiment the arm member may be a fixed arm member. In another embodiment, the arm member may be moveable or a robotic arm member.

In another embodiment, the mounting media device may include one or more mounting brackets secured to the housing to secure the mounting media device to a structure. In yet another embodiment, the mounting media device may include a reservoir element configured to receive a cleaning solvent such as xylene which may be positioned to receive the needle tip when the dispenser component is not in use.

In one embodiment, the syringe component may be a piston pump including a plunger member that fits snugly in a tube member. The syringe component may further include an electronic control in combination with mechanical gears to control movement of the plunger. The plunger member can be reciprocated along the inside of the tube member at a manual or automatic pre-programmed sequence. The reciprocation of the plunger may allow the syringe component to take in and expel mounting media through a pair of valve members at one end of the tube element. The syringe component may be of different sizes and made of glass, although any material is contemplated. It is also contemplated that the syringe component is disposable and may further be sterile for certain applications such as those that pertain to Deoxyribonucleic Acid (“DNA”). The syringe component may also be preloaded with mounting media for simplified use with the device. The syringe component may come in various amounts of sizes including those ranging from 0.5 ml to 1000 ml. The dispenser component may be at least partially enclosed by the housing and include a needle tip. The needle tip may be formed of plastic or metal materials.

In a manual mode, the syringe component, more particularly the syringe valve members and gear members, may be activated by a foot pedal element—a lever that is activated by a user's foot—to control the amount of pressure applied by the plunger to the mounting media provided to the dispenser component. A slide on the tray component may be positioned in conjunction with the needle tip to receive mounting media passed through the syringe component and the dispenser component.

The syringe component may include an electronic piston pump plunger mechanism to dispense mounting media from the syringe component and to the dispenser component. In other embodiments an air compressor, manual mechanism, or gravity mechanism is contemplated as an alternative pump or spray member to dispense mounting media from the syringe component.

The manual mode allows manual selection of an exact time sequence for syringe component operation, including speed of plunger member movement and amount of plunger member movement in precise increments as the plunger member moves in a direction to expel mounting media.

The mounting media device also includes an automatic mode. The automatic mode may have a pre-programmed time sequence for plunger movement. The speed of the plunger member may also be automatic. In one embodiment of the automatic mode, when the tray component is positioned and a signal is generated from one or more of a magnetic sensor, trigger switch, or optical sensor, then the syringe component provides mounting media to the dispenser component at a specified time sequence. The dispenser component then dispenses mounting media that is released from the needle tip onto a specimen positioned on a slide. A cover slip may then cover the specimen and a portion of the slide and the specimen may be viewed under a microscope.

The tray component may operate with either the manual mode or the automatic mode. The tray component may include an underlayer having tracks that allow movement of the tray component in different directions to permit positioning of slides under the needle tip. Thus, mounting media can be directly applied to the slide, preferably in a central location on a specimen positioned on the slide.

In one embodiment, a track motor automatically repositions the tray component along tracks based on data collected by one or more sensors. This allows each slide positioned on the tray element to be positioned under the needle tip prior to dispensing mounting media from the needle tip. In another embodiment, the tray component is configured to move when an external force is applied to the tray component. The movement of the tray component may be constrained by one or more tracks, and the tracks may allow the tray component to lock into place in certain positions for optimal application of mounting media to slides positioned on the tray component. The tray component may be formed of cardboard or any other material. The tray component may have an underlayer, an intermediate layer, and an upper layer. The upper layer may have recesses for receiving one or more slides. In one embodiment, the underlayer is plastic with a central pivoting point. In another embodiment, the underlayer may include roller bearings that allow unrestricted movement of the tray component. In one embodiment the underlayer is formed from brass, however any other type of metal may be used. The underlayer may further include springs or other biasing members that allow movement of the underlayer in certain directions based on the applied spring biases.

In one embodiment, the tray component may contain one to one hundred slides that are fitted in a recessed cardboard tray that securely holds each individual slide. The tray component may have an upper layer and an intermediate layer that mount directly and securely to an underlayer.

An object of the present invention is to provide a media mounting device that replaces a manual application of mounting media.

Another object of the present invention is to provide a media mounting device that is lower in cost than conventional media mounting devices.

Another object of the present invention is to provide a media mounting device that is triggered by a foot pedal element.

Another object of the present invention is to provide a media mounting device that is automatically triggered by an optional sensor providing a signal to a control element.

Another object of the present invention is to provide a media mounting device with preloaded syringe components having mounting media.

Another object of the present invention is to provide a media mounting device with disposable syringe components.

Another object of the present invention is to provide a media mounting device that is self-contained.

Another object of the present invention is to provide a media mounting device that operates a syringe component at a low pressure.

Another object of the present invention is to provide a media mounting device that has a filter for filtering the air.

Another object of the present invention is to have a media mounting device having a housing provided with a base and a tray component capable of being positioned on the base.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates a mounting media device according to one embodiment the invention;

FIG. 2 illustrates a perspective view of a mounting media device having a tray component removed according to the embodiment of FIG. 1 of the invention;

FIG. 3 illustrates a perspective view of a mounting media device having a filter according to one embodiment of the invention;

FIG. 4 illustrates a partial top view of a mounting media device including a fan and filter assembly according to one embodiment of the invention;

FIG. 5 illustrates a partial side view of a mounting media device including a filter cover according to one embodiment of the invention;

FIG. 6 illustrates a rear panel of the housing of a mounting media device according to one embodiment of the invention;

FIG. 7 illustrates an interior of the mounting media device according to one embodiment of the invention;

FIG. 8 illustrates an interface of the syringe component of the mounting media device according to one embodiment of the invention;

FIG. 9 illustrates an upper layer and an intermediate layer of a tray component according to one embodiment of the invention; and

FIG. 10 illustrates tracks of an underlayer of the tray component according to one embodiment of the invention.

### DETAILED DESCRIPTION OF THE PREFERRED EMBODIMENT

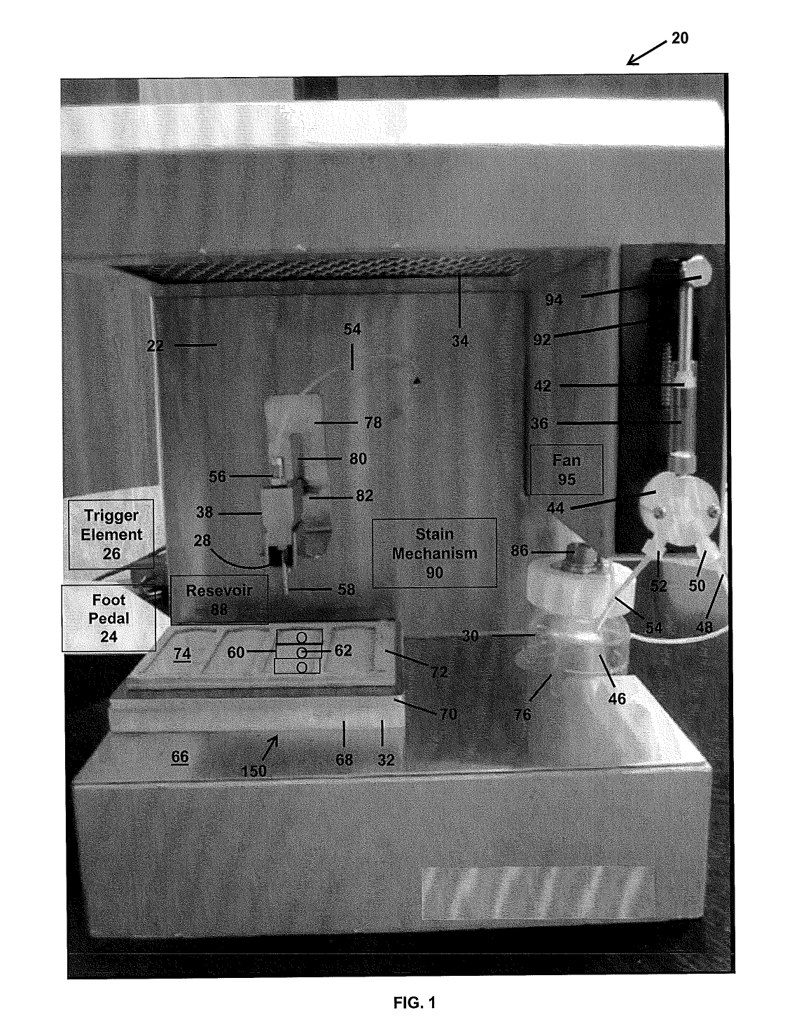

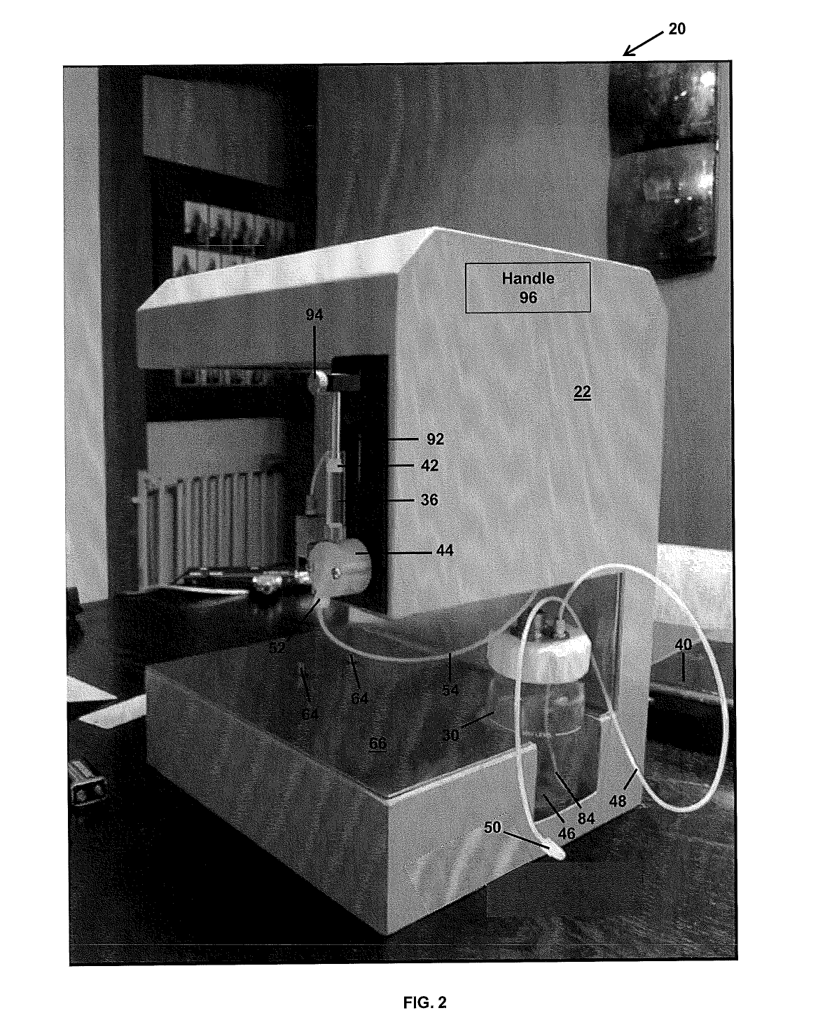

FIGS. 1 and 2 show one embodiment of a mounting media device 20. The device 20 includes a housing 22, a foot pedal element 24, a trigger element 26, a sensor 28, a container 30, and a tray component 32. The device 20 also includes a fan and filter assembly 34 and a mounting media transfer component 36. The mounting media transfer component 36 in this embodiment is a syringe component. The mounting media device further includes a dispenser component 38, and a control element 40 which is best seen in FIG. 2.

The foot pedal element 24, trigger element 26, sensor 28, and syringe component 36 may be connected to the control element 40. In one embodiment, signals provided from the foot pedal element 24, trigger element 26, and sensor 28 provide inputs to the control element 40 to determine whether the syringe component 36 is activated to reciprocate a plunger 42 toward and away from a collector 44. Upon reciprocation of the plunger 42 away from the collector 44, mounting media 46 within the container 30 is suctioned through a first tube 48 and a first valve 50 to the collector 44 and the syringe component 36. Upon reciprocation of the plunger 42 toward the collector 44, the first valve 50 is closed and prevents mounting media 46 from flowing to the container 30 and a second valve 52 is open and allows mounting media 46 to flow from the syringe component 36 through a second tube 54 to the dispenser component 38. The second valve 52 is closed when the plunger 42 moves away from the collector 44 and mounting media again enters the collector 44 and syringe component 36. The first valve 50 and second valve 52 may be mechanical one-way valves, or may be operated by the control element 40. In one embodiment the control element 40 may alternately open and close the first valve 50 and the second valve 52 based on movement of the plunger 42.

The device 20 may be operated in an automatic mode, a manual mode, or a combination of these modes. In the automatic mode, operation of the device 20 including activation of the syringe component 36 occurs automatically based on a pre-programmed schedule controlled by the control element 40. In the manual mode, an operator may access the control element 40 to select the schedule for activation of the syringe component 36. The operator may also actuate the trigger element 26 to cause an actuation of the syringe component 36. In one embodiment, the control element 40 may be a computer or other hand-held computing device that communicates with the other components via a hard-wired connection or a wireless connection.

The dispenser component 38 includes a fastener 56 for securing the second tube 54 to the dispenser component 38. The dispenser component 38 further includes a needle tip 58 for dispensing mounting media 46 to the tray component 32. The dispenser component 38 may further have the sensor 28 secured thereto to determine the position of the needle tip 58 relative to a slide 60 positioned on the tray component 32 to allow dispensing of mounting media 46 to a specific location. Multiple slides 60 may be positioned on the tray component 32. Each of the slides 60 has a central location having a specimen 62 deposited thereon. The sensor 28 can determine when the needle tip 58 is located above the central location of the slide 60 and provide a signal to the control element 40 indicating that dispensing of mounting media 46 may occur to secure the specimen 62 to the slide 60.

The tray component 32 may be repositioned to place another slide 60 in a position under the needle tip 58 for receiving the mounting media 46. As shown in FIG. 2, which shows the housing 22 with the tray component 32 removed, the housing 22 includes a pair of protrusions 64. The protrusions 64 are formed on a base 66 of the housing 22. The protrusions 64 may engage the tray component 32 and permit limited movement of the tray component 32 to position slides 60 under the needle tip 58.

As shown in FIG. 1, the tray component 32 includes an underlayer 68 configured to engage the pair of protrusions 64, an intermediate layer 70, and an upper layer 72. The upper layer 72 includes recesses 74 configured to receive one or more of the slides 60.

The housing 22 may also include a recessed portion 76 that is configured to receive the container 30. Preferably the recessed portion 76 provides a snug fit to limit movement of the container 30 during operation of the syringe component 36.

The device 20 may further include a clamp 78 for securing the dispenser component 38 to the housing 22. The clamp 78 may include a slotted portion 80 for adjusting the height of the clamp 78 and the dispenser component 38 above the tray component 32. A fastener 82 can secure the clamp 78 to the housing 22.

The container 30 may be formed of a variety of materials. In one embodiment, the container 30 is a glass jar. The tube 48 can be connected to the container 30 and receive mounting media 46 through an inner tube 84 that is located within the container 30 as best seen in FIG. 2. The container 30 may also include a pressure relief valve 86 for relieving pressure in the container 30 as mounting media 46 is suctioned from the container 30 and into the collector 44 and syringe component 36.

The device 20 may also include a reservoir 88 and a stain mechanism 90. The reservoir 88 may be positioned under the needle tip 58 when the device is not in use. The reservoir 88 may include a solution which prevents clogging of the need tip 58. The stain mechanism 90 may include a bracket and cups configured to secure to the bracket. The containers may store stain fluids. By way of example, in one embodiment the cups could separately contain dye, alcohol, and xylene fluids.

The syringe component 36 may further include a gear assembly 92 to control movement of the plunger 42. The gear assembly 92 may include a thumb screw 94 to further control air pressure provided to the syringe component 36.

As shown in FIG. 1, an external fan 95 may attach to the housing 22 to dry slides 60 positioned on the tray component 32.

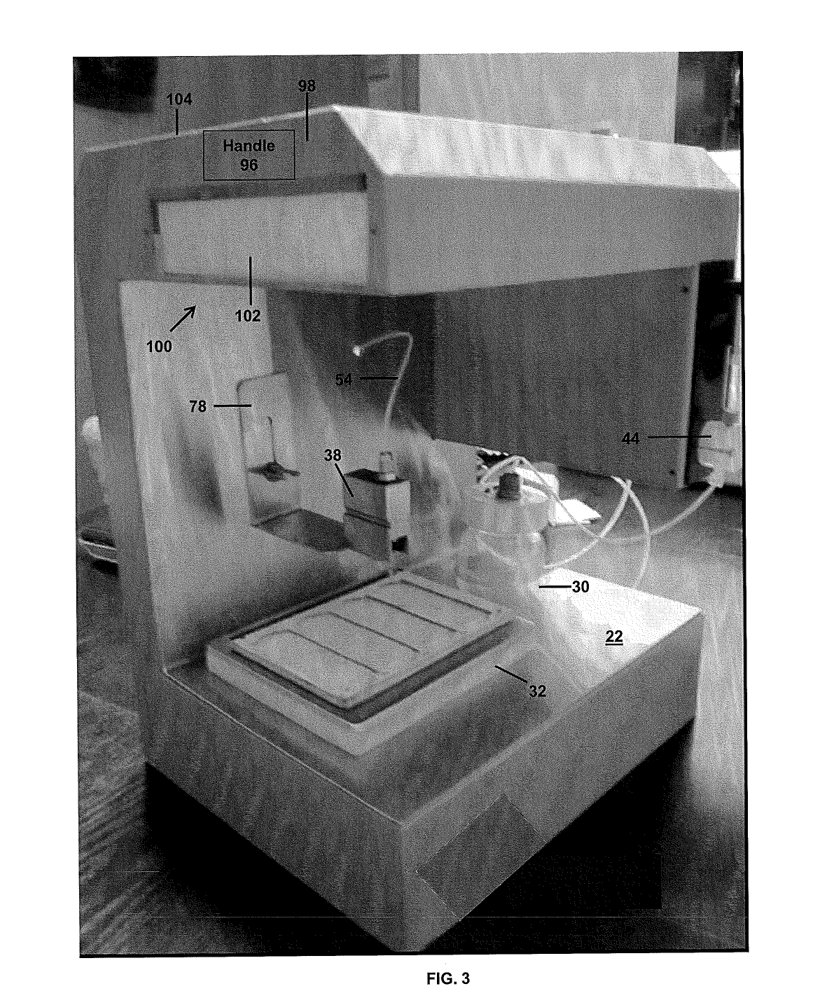

As shown in FIG. 2 and FIG. 3, the device 20 may include one or more handle members 96 for transporting the device 20. FIG. 3 shows one side 98 of the housing 22 which includes an opening, shown generally as 100. The opening 100 is configured for receiving a filter 102. In one embodiment, the filter 102 is a charcoal filter that may remove fumes released when the mounting media 46 is dispensed to the slide 60.

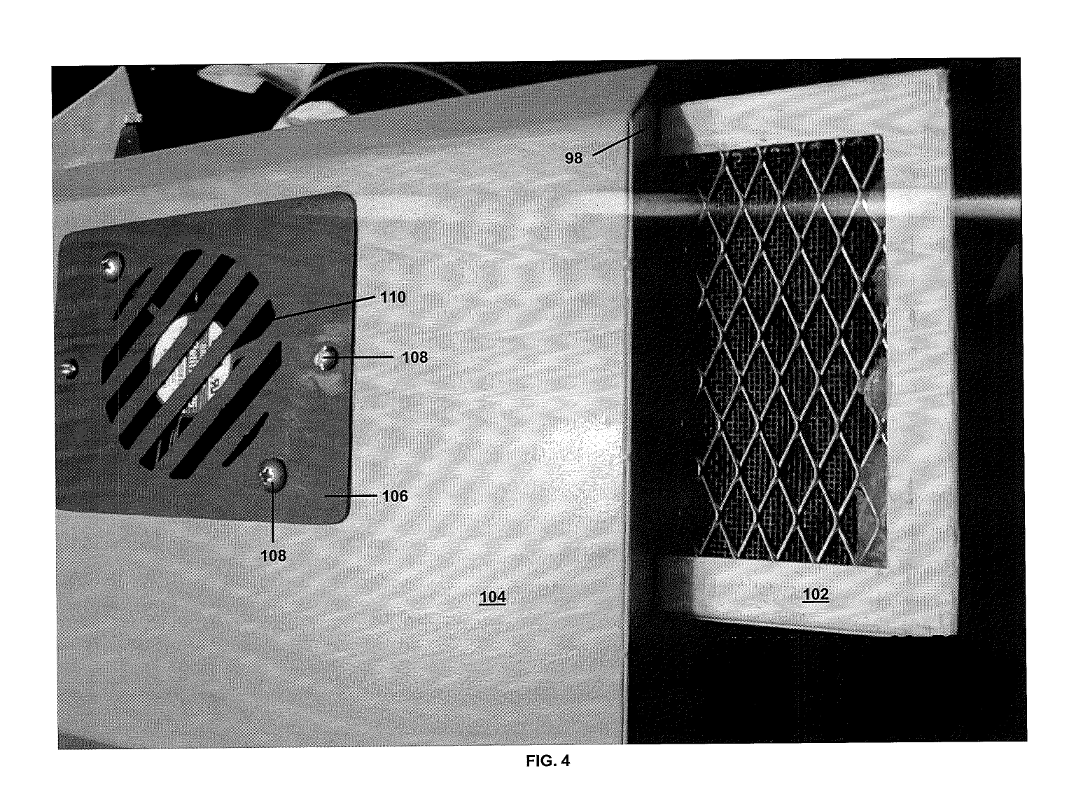

As best seen in FIG. 4, a top surface 104 of the housing 22 is configured to receive a fan 106. The fan 106 may be secured to the housing 22 by fasteners 108. The fan 106 includes air vents 110 that facilitate airflow into and through the filter 102. The filtered air then exits through the air vents 110.

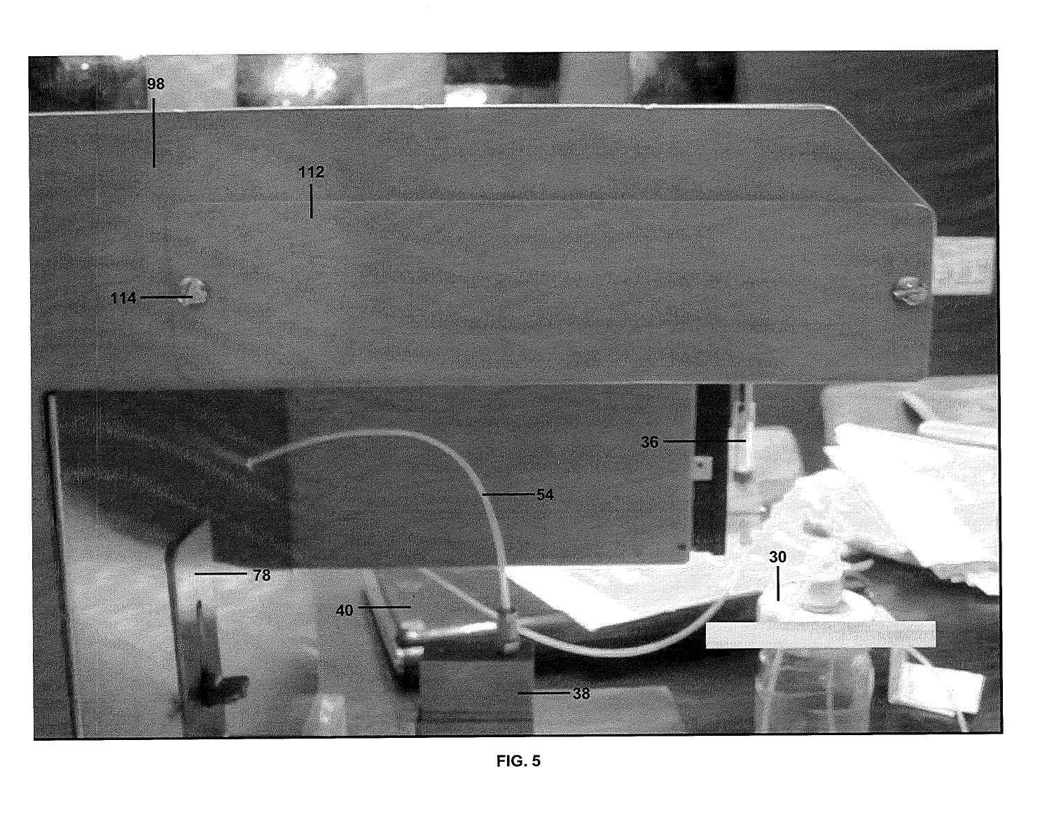

FIG. 5 shows a cover 112 that may be secured by fasteners 114 to the side 98 of the housing 22. The cover 112 protects the filter 102 from dust or other contaminants and also prevents dislodging of the filter 102 from the housing 22.

The housing 22 may be formed various materials. In one embodiment the housing 22 is generally C-shaped and formed of stainless steel and metal material. However, other materials are contemplated for forming the housing 22 as is known to those skilled in the art.

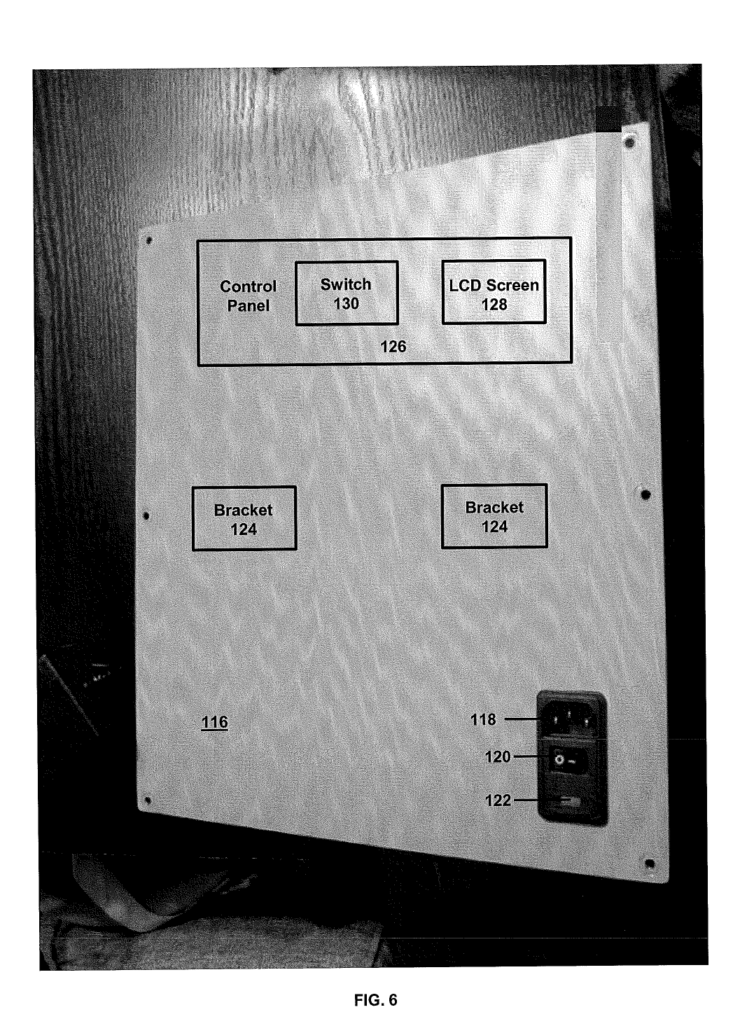

FIG. 6 shows a rear portion of the device 20 including a removable panel 116. The device 20 may be powered by one power cord at plug interface 118. However, it is contemplated that more than one power cord may be used to power the device 20. A power switch 120 may control power to the device 20. An indicator 122 can provide a visual identifier to specify the current “power on” or “power off” status of the device 20.

The device 20 may optionally include mounting brackets 124 for mounting the device 20 to a structure (not shown). The device 20 may also optionally include a control panel 126 that may include a LCD touch screen 128. The control panel 126 may interface with the control element 40. In an alternative embodiment, the control panel 126 may replace the control element 40 for operating the syringe component 36 and other components of the device 20. Although the control panel 126 is positioned on the panel 116, it is envisioned that the control panel 126 may be located anywhere on the housing 22.

The control panel 126 may further include in one embodiment an automatic/manual switch 130 that selects the operating mode of the device 20. Instead of the switch 130, the device 20 may operate in manual mode with the foot pedal element 24. The device may operate in automatic mode with the optical sensor, trigger element, or magnetic sensor providing a signal to the control panel 126. In either of the manual mode and automatic mode, the control panel 126 may provide an exact time sequence to which the dispenser component 38 dispenses mounting media 46 and a specified air pressure provided to the syringe component 36 during dispensing of the mounting media 46. The control panel 126 may provide a time sequence for reciprocation of the syringe component 36. When the syringe component 36 is activated in the manual mode or the automatic mode, mounting media 46 from the syringe component 36 may be supplied to the dispenser component 38 at the programmed time sequence when the sensor 28 indicates that a slide 60 is positioned under the needle tip 58. The control panel 126 may prevent dispensing of mounting media 46 when the sensor 28 indicates that the slide 60 is not properly positioned under the needle tip 58.

The control element 40 may optionally be a laptop computer having a LCD display. In one embodiment, the control element 40 may display a numerical count up to the programmed time. The LCD display may provide a graphical user interface that configures all settings for the manual mode and the automatic mode.

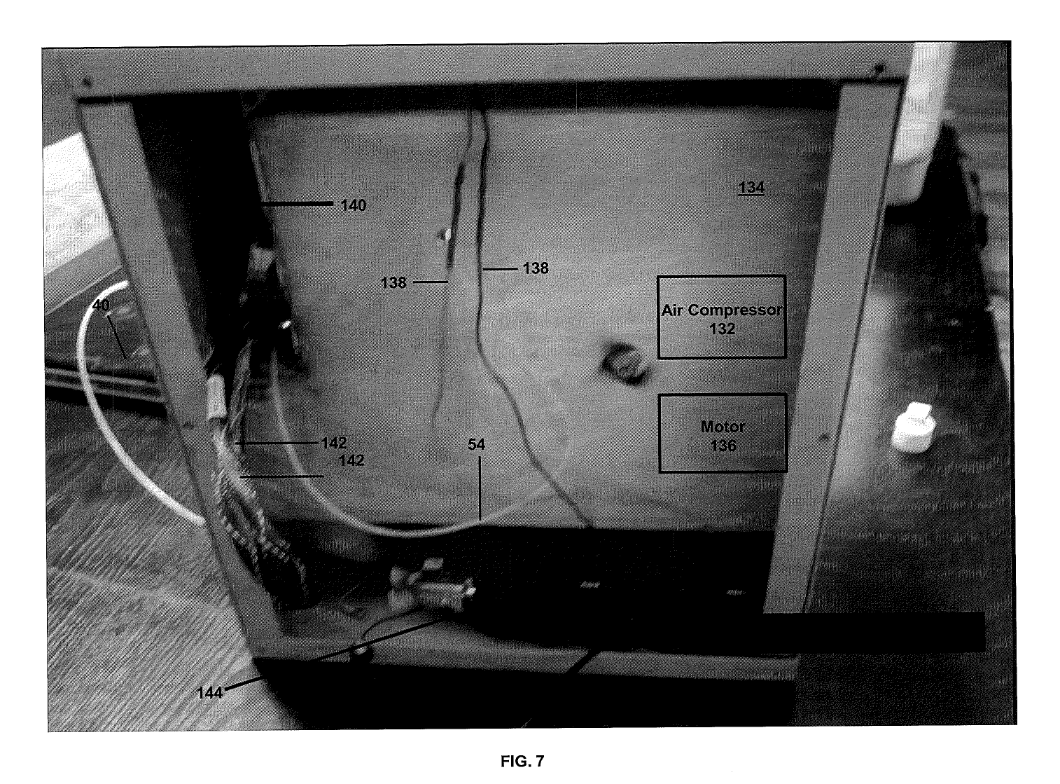

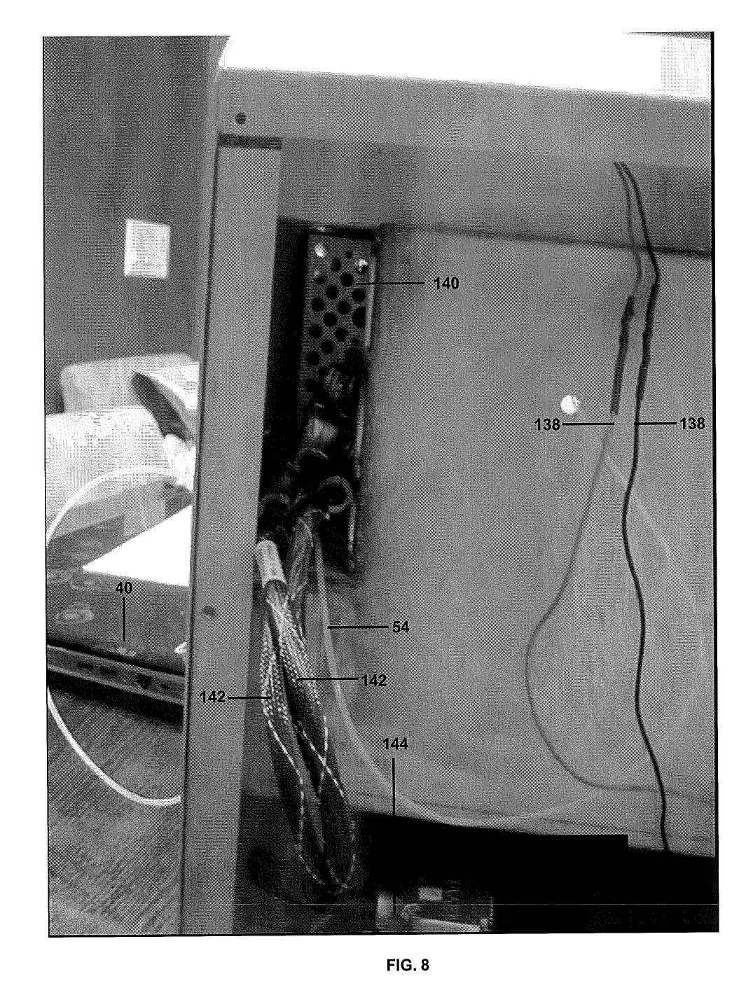

FIG. 7 illustrates the interior of the housing 22 of the device 20 according to one embodiment of the invention. As shown in FIG. 7, an air compressor 132 is mounted to a wall 134 of the housing 22. The air compressor 132 may provide air at a specified pressure to the syringe component 36. In one embodiment, the syringe component 36 may include a valve member that is activated by the foot pedal element 24 to control the amount of air pressure provided to the syringe component 36. A track motor 136 may also be mounted to the wall 134. The track motor 136 may operate a tray component 32 that is configured to be electrically driven. The interior of the housing 22 may also include power lines 138 for supplying power to the fan 106. As best seen in FIG. 8, the syringe component 36 may include an interface 140 that receives communication lines 142 that provide information via a transmitter 144 to the control element 40 or optionally the control panel 126.

In one embodiment, the manual mode allows control of the syringe component 36 and the dispenser component 38 if the foot pedal element 24 is depressed. More specifically, while the foot pedal element 24 is depressed, the release of air to the syringe component 36 is capable of being manually controlled. The mounting media 46 within the syringe component 36 is capable of being transferred from the syringe component 36 to the needle tip 58 and onto a specimen 62 as a single shot. The specimen 62 may then be manually covered by a cover slip (not shown).

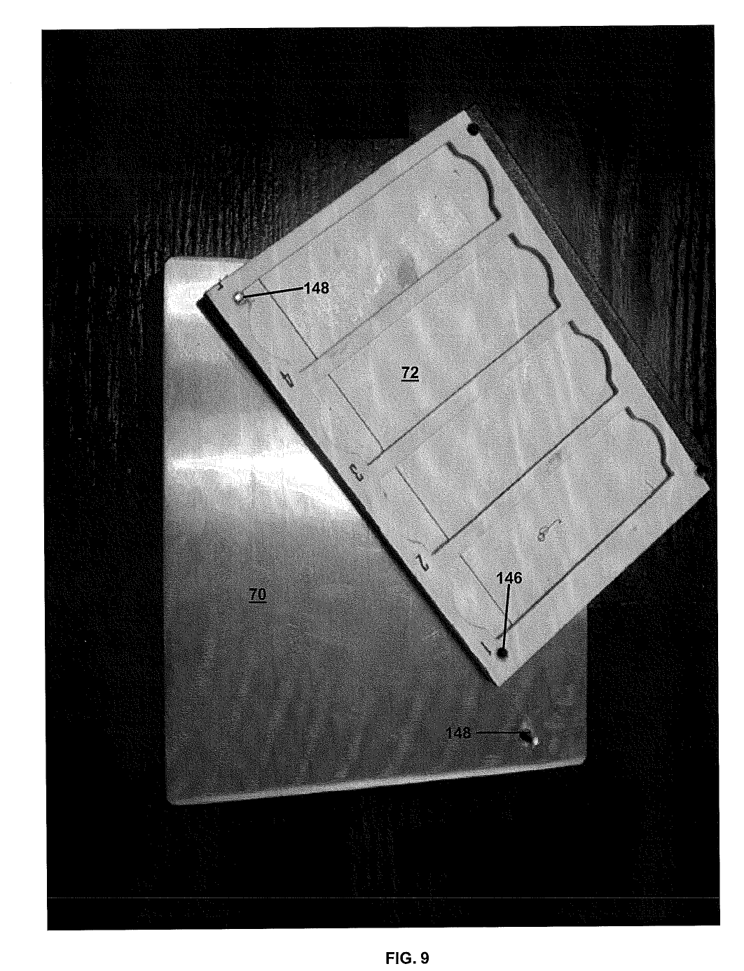

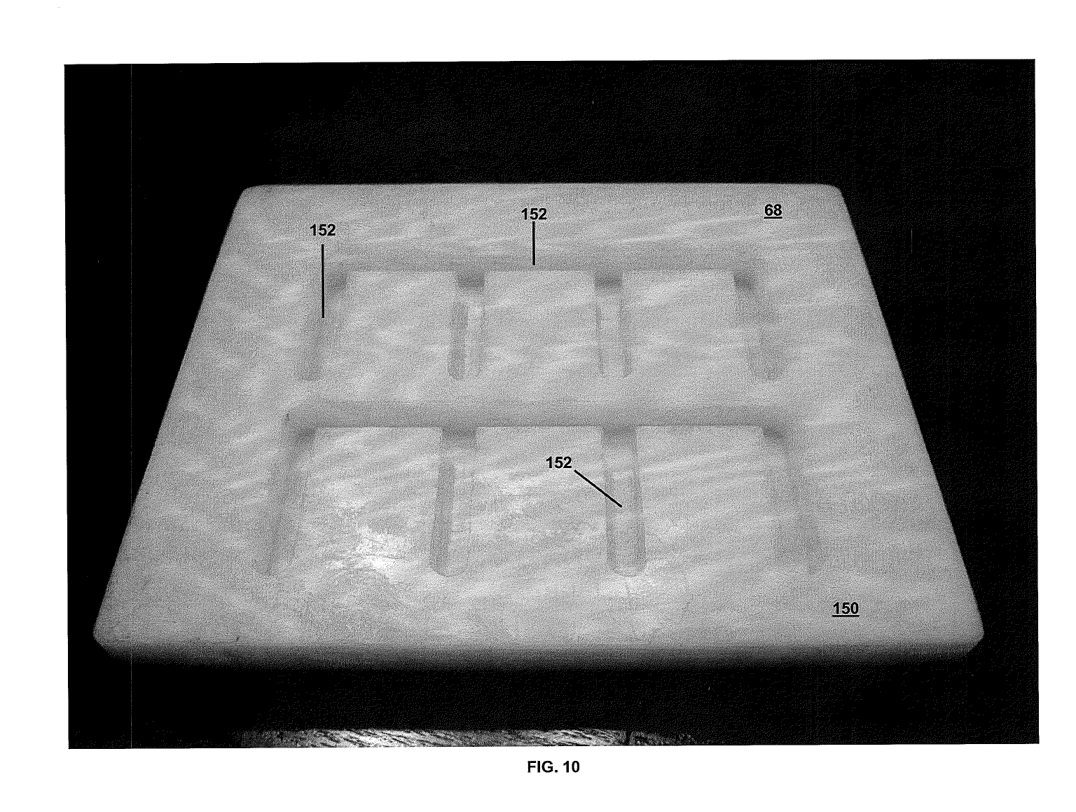

Turning now to FIGS. 9 and 10, one embodiment of a tray component 32 is illustrated. FIG. 9 shows the upper layer 72 partially secured to the intermediate layer 70. The upper layer 72 includes one or more apertures 146 configured to engage protrusions 148 of the intermediate layer 70. The protrusions 148 cause the upper layer 72 to remain fixed to the intermediate layer 70. The apertures 146 are sufficiently sized to permit removal of the upper layer 72. In this manner, different sets of slides provided with separate upper layers may be quickly secured to the intermediate layer 70.

FIG. 10 shows an underside 150 of the underlayer 68. The underlayer 68 includes a plurality of tracks 152 that are configured to receive the pair of protrusions 64 shown in FIG. 2. When the tracks 152 are engaged by the protrusions, the underlayer 68 and hence the tray component 32 may be repositioned on the base 66 of the housing 22 to facilitate alignment of the slides 60 under the needle tip 58. The tracks 152 are shown as longitudinal and transverse lines, however it is envisioned that the tracks can include a myriad of shapes and include indentations for facilitating alignment of the tray component 32 relative to the needle tip 58. While the present underlayer 68 may be manually repositioned, it is envisioned that a motorized tracking system using ball bearings or other gearing mechanisms may be utilized to reposition the tray component 32.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. A mounting media device for application of mounting media to one or more slides before placement of cover slips on the slides, comprising:
a housing having a base;
a tray component configured to receive the one or more slides and capable of being moved on said base;
a mounting media transfer component;
a dispenser component configured to receive the mounting media from said mounting media transfer component and deposit the mounting media in increments to each of the slides; and
a control element configured to control the deposit of the mounting media to each slide.

2. The mounting media device of claim 1, wherein the mounting media from said mounting media transfer component is dispensed into said dispenser component at a specified pressure.

3. The mounting media device of claim 1, wherein the mounting media from said mounting media transfer component is dispensed into said dispenser component according to a programmed time sequence.

4. The mounting media device of claim 1, wherein the mounting media device comprises a syringe component including a first valve for receiving mounting media in said syringe component and a second valve for transferring the mounting media to said dispenser component.

5. The mounting media device of claim 4, wherein said first valve and said second valve are opened and closed according to a programmed sequence to transfer the mounting media from said syringe component to said dispenser component.

6. The mounting media device of claim 1, wherein said housing includes one or more handle members.

7. The mounting media device of claim 1, wherein said housing includes a control panel configured to control dispensing of the mounting media from said dispenser component to the one or more slides.

8. The mounting media device of claim 7, wherein said control panel includes a liquid crystal display touch screen.

9. The mounting media device of claim 4, wherein said syringe component and said dispenser component are disposable components.

10. The mounting media device of claim 1, wherein said control element includes a foot pedal configured to be depressed to operate the mounting media transfer component in a manual mode.

11. The mounting media device of claim 1, wherein said control element includes an optical sensor switch configured to be activated by said tray component to operate the mounting media transfer component in an automatic mode.

12. The mounting media device of claim 1, wherein said control element includes a magnetic sensor switch configured to be activated by the tray component to operate the mounting media transfer device in an automatic mode.

13. The mounting media device of claim 1, wherein the liquid crystal display touch screen is configured to be manually programmed to deposit the mounting media in increments to each of the slides.

14. The mounting media device of claim 1, further comprising a fan and filter assembly connected to said housing.

15. The mounting media device of claim 14, wherein said filter is a charcoal filter.

16. The mounting media device of claim 1, wherein said tray component includes an underlayer having tracks for moving the tray component along said base.

17. The mounting media device of claim 1, further comprising a track motor configured to automatically move said tray component.

18. The mounting media device of claim 1, further comprising an external fan configured to apply air to the one or more slides.

19. The mounting media device of claim 1, further comprising a container connected to said mounting media transfer component, said container configured to contain mounting media and transfer mounting media to said mounting media transfer component.

20. The mounting media device of claim 19, wherein said container includes a pressure relief valve.
